(19) United States
(12) Patent Application Publication
(10) Pub. No.: US 2026/0275164 A1
(43) Pub. Date: Sep. 17, 2026

(54) INORGANIC LIQUID GLUES

(71) Applicant: Katholieke Universiteit Leuven, Leuven (BE)

(72) Inventors: Yiannis Pontikes, Kessel-Lo (BE); Vincent Hallet, Herentals (BE); Yakinthi Avtzi, Leuven (BE)

(21) Appl. No.: 19/474,502

(22) PCT Filed: Apr. 15, 2024
(86) PCT No.: PCT/EP2024/060190

§ 371 Date: Oct. 10, 2025

(30) Foreign Application Priority Data
Apr. 14, 2023 (EP) 23168052.1

(51) Int. Cl. C09J 1/02; C09J 11/08

(52) U.S. Cl. CPC C09J 1/02; C09J 11/08

(57) ABSTRACT

The invention relates to method for preparing an inorganic glue from an Fe-comprising material, comprising the step of milling the Fe-comprising material with a liquid, the liquid comprising a compound complexing Fe(II) under alkaline conditions.

### FIELD OF THE INVENTION

The invention relates to the synthesis of an inorganic, liquid glue using wet milling procedures.

### BACKGROUND OF THE INVENTION

In a wide-range of applications there is need for an adhesive layer to hold together elements, or for a coating. Examples in the first domain include adhesives for wood, sealants in concrete or brick structures, but also the binder of a mortar or a concrete, whereas in the second domain, examples include coatings for wood, ceramics or concrete, offering a particular functionality. This functionality of the coating can offer, for example, protection of the substrate material from a fire, or self-cleaning properties due to the super-hydrophilicity.

Nowadays, such materials are polymer-based, thus primarily composed of carbon-atoms. These materials come at a high cost and environmental impact and cannot withstand high temperatures. Examples are urethanes, epoxies, resins, cyanoacrylates and methacrylates.

Inorganic adhesives exist in the market as well. For instance, the TB3732 [Three Bond International, TB3732-heat resistant inorganic adhesive, (2004).] is a white alumina-based paste. Other adhesives are listed in the literature, e.g. in the patent literature (U.S. Pat. No. 4,775,414A) and several others listed in state-of-the-art academic literature [Chen et al Ceram. Int. 45 (2019) 8684-8689; Yu et al. Structures. 33 (2021) 2099-2120]. Yet, in all the cited literature and references therein, there is no reference for Fe-rich adhesives. Still, there is work conducted by a number of groups on Fe-rich inorganic polymers and Fe-rich cements and these materials could be used as the material described herein [Arnout et al. Waste and Biomass Valorization. (2021) 1-31; Ponomar et al. J. Clean. Prod. 330 (2022) 129900; Peys et al. J. Am. Ceram. Soc. 101 (2018) 5846-5857]. Moreover, in Van De Sande et al. J. Eur. Ceram. Soc. 42 (2022) 6222-6235, the high temperature resistance of such materials is demonstrated.

The use of Fe-rich adhesives encompasses several challenges which need to be overcome for their commercialization:
(1) The Fe-rich raw materials for these adhesives are typically Fe-rich glassy solids, such as non-ferrous metallurgical slags, and need to be milled in order to be used, which has been shown to be significantly more energy intensive than some components of other inorganic adhesives, such as Portland clinker and ground granulated blast furnace slag (GGBFS) [Baragano & Rey, Proc. 7th Int. Congr. Chem. Cem., Paris, 1980: pp. III-37-42].
(2) Precursor raw materials for Fe-rich adhesives often contain heavy metals which need to be mitigated in order to avoid leaching issues. While these heavy metals can be immobilised in reaction products of the inorganic adhesive (as described in the patent WO2020025691A1 Fe-rich binder), there's still a risk for the products second life.
(3) The inorganic adhesive should be more sustainable than other inorganic binders such as cement.

All the previously mentioned works on Fe-rich binders have in common that the raw materials, Fe-rich glassy solids, have been milled in a dry state without additives for the purpose of scientific research. In order to address the above mentioned challenge (1), more energy efficient milling could be achieved by the use of grinding aids. Grinding aids are considered as, typically surface-active, chemicals which are added in very small dosage (<0.1 wt. % of the solids) to reduce the grinding energy and improve mill throughput [Fuerstenau et al. Int. J. Miner. Process. 15 (1985) 251-267]. Typically, these chemicals, e.g. alkanolamines or polycarboxylate ethers, lead to repulsive forces between the particles and thereby reduce energy consumption of the milling process. Another path for enhancing milling efficiency is the use of wet milling rather than dry milling since, unlike cements, the Fe-rich glassy solids don't hydrate in water and therefore this barrier for milling in a liquid state doesn't exist. Furthermore, the inorganic adhesives herein are expected to be in liquid form, which opens the path for wet milling. Yet, milling Fe-rich glassy solids in water results in a powder that cannot be used as inorganic adhesive. Addition of carbon has proven to be unsuccessful.

### SUMMARY OF THE INVENTION

The invention is summarised in the following statements:
1. A method for preparing an inorganic glue from an Fe-comprising material, wherein the Fe-comprising material has an Fe content expressed as Fe₂O₃ of at least 15 wt. %,
wherein the Fe-comprising material is between 5 and 100 wt. % amorphous, and,
wherein the Fe-comprising material has an Fe²⁺/(Fe⁰+Fe²⁺+Fe³⁺) ratio of between 0.05 and 1,
the method comprising the step of milling the Fe-comprising material with a liquid, the liquid comprising a compound complexing Fe(II) under alkaline conditions, wherein the compound complexing Fe(II) is a Li, Na or K silicate, in a concentration expressed as SiO₂, of at least 0.15 wt. % of the Fe-comprising material,
or wherein the compound complexing (FeII) comprises at least one salt having a functional group selected from sulphonate, cyanide, phosphate, phosphonate, amine, nitrate, thiocyanide, ferrocyanide, or an organic acid salt thereof, including aminopolycarboxylic acids and salts, in a concentration of between 0.001 to 5 wt. % of the Fe-comprising material,
or wherein compound complexing (FeII) is selected from the group consisting of alkali silicate, an alkanolamine, a sugar or a sugar derivative with oxygen, nitrogen, sulphur or phosphorous anchoring donor groups, an organic acid such as ascorbic acid or tannic acid, a polyaminocarboxylate, such as EDTA, a molecule comprising a N═C—C═N moiety such as bipyridine or ferrozine, and a phosphonate.

The amount of silicate being use can range from 0.15 wt. %, 0.5 wt. %, 1 wt. %, 5 wt. % up 50 wt. %, 100 wt. %, 500 wt. % or 1500 wt. %, including all ranges formed by the above lower and upper values. When large volumes of liquid are used with high concentrations of silicate the excess over the Fe(II) comprising will be high. In certain methods the solid part is separated from such highly concentrated liquid after milling and the liquid is re-used for a new batch of iron-comprising glass. In such methods, the silicate will gradually decrease.
2. The method according to claim 1, wherein the compound complexing Fe(II) is Li, Na, or K silicate.
3. The method according to claim 1 or 2, wherein the compound complexing Fe(II) is Li, Na, or K silicate, in a concentration expressed as SiO₂, of at least 1.5 wt. %, or of at least 15 wt. % of the Fe-comprising material.
4. The method according to any of claims 1 to 3, wherein the Fe-comprising material has an Fe²⁺/(Fe⁰+Fe²⁺+Fe³⁺) ratio of between 0.5 and 1.0.
5. The method according to any one of claims 1 to 4, wherein the Fe-comprising material has an Fe²⁺/(Fe⁰+Fe²⁺+Fe³⁺) ratio of between 0.75 and 1.0.
6. The method according to any one of claims 1 to 5, wherein the Fe comprising material has an Fe content expressed as Fe₂O₃ of at least 30 wt. %.
7. The method according to any one of claims 1 to 6, wherein the Fe comprising material has an Fe content expressed as Fe₂O₃ of at least 50 wt. %.
8. The method according to any one of claims 1 to 7, wherein the Fe comprising material has an Fe content expressed as Fe₂O₃ of at least 70 wt. %.
9. The method according to any one of claims 1 to 8, wherein the Fe-comprising material is more that 30% amorphous.
10. The method according to any one of claims 1 to 9, wherein the Fe-comprising glass is more that 50% amorphous.
11. The method according to any one of claims 1 to 10, wherein the wet milling is performed at a pH of >7, typically >pH 10, preferably >pH 12.
12. The method according to any one of claims 1 to 11, wherein the alkaline conditions are induced by an alkaline solution, selected from one or more of the group consisting of hydroxides, silicates, sulphates, sulphides, sulphites, carbonates of Li- and/or Na- and/or K- and/or Ca, spent Bayer liquor, and Na-aluminate solution [which is the liquid component of bauxite residue slurry].

In embodiments wherein silicates are used as Fe(II) complexing agent, silicates are typically not used as a further added compound to raise the pH.
13. The method according to any one of claims 1 to 11, wherein the alkaline conditions are provided by adding a Si-containing compound to a Li, Na, K or Ca containing solution.
14. The method according to any one of claims 1 to 13, where first an alkaline solution and a Si-containing compound are mixed, and subsequently the Fe-comprising material is added.
15. The method according to any one of claims 1 to 14, wherein the compound complexing Fe(II) is at a concentration of between 0.5 wt. % and 1, 5, 10, 20, 25, or 50% of the Fe-comprising material.
16. The method according to any one of claims 1 to 15, wherein the Fe-comprising material is selected from the group consisting of non-ferrous metallurgical slag from Cu, Pb, Pb—Zn, Zn, Fe—Ni, Ni and P metallurgy.
17. The method according to any one of claims 1 to 15, wherein the Fe-comprising material is selected from the group consisting of vitrified bauxite residue, vitrified ash, and slag from sinter plants or high temperature furnaces, such as Basic Oxygen Furnace, Top-Blown Rotary Converter, induction furnaces, and Electric Arc Furnaces, or a microwave-assisted version of one of these.
18. The method according to any one of claims 1 to 17, wherein the particles in the Fe-comprising material prior to the milling have an average size of less than 1 cm or less than 5 mm.
19. The method according to any one of claims 1 to 18, wherein the milling is performed at a temperature up to 350° C., for example between 225° to 245° C.
20. The method according to any one of claims 1 to 19, wherein the milling is performed at a pressure of up to 90 bar, for example between 27 to 32 bars pressure.
21. The method according any one of claims 1 to 20, wherein the milling is performed until a product is obtained with a specific Blaine surface of between 1000 cm²/g and 7000 cm²/g. 15
22. The method according any one of claims 1 to 20, which is performed until particles are obtained with an average particle size <1 mm, more particularly <100 μm.
23. The method according to any one of claims 1 to 22, followed by the step of adding one or more plasticizing agent, such as a naphthalene-based superplasticizer, a lignosulphate, a naphthalene sulphonate, a protein, a melamine-based superplasticizer, a polyamide, a polycarboxylic ether (PCE) or polacrylicether (PAE)
24. The method according to any one of claims 1 to 23, followed by a step of removing heavy metals from the liquid with milled Fe-comprising material. This can be done e.g. by precipitation of heavy metals as constituents of insoluble particles. Or by removing the liquid phase.
25. The method according to any one of claims 1 to 24, followed by a step of storing the milled Fe-comprising material as a moist product.
26. A method for preparing an inorganic glue from an Fe-comprising glass, comprising the step of wet milling the Fe-comprising glass in alkaline conditions in the presence of a compound complexing Fe(II),
wherein the Fe-comprising glass has an Fe content expressed as Fe₂O₃ of at least 15 wt. %,
wherein the Fe-comprising glass is between 5 and 100 wt. % amorphous glass, and,
wherein the Fe-comprising glass has an Fe²⁺/(Fe⁰+Fe²⁺+Fe³⁺) ratio of between 0.05 and 1.
27. The method according to statement 26, wherein the Fe-comprising glass has an Fe²⁺/(Fe⁰+Fe²⁺+Fe³⁺) ratio of between 0.5 and 1.
28. The method according to statement 26 or 27, wherein the iron comprising glass has an Fe content expressed as Fe₂O₃ of at least 30 wt. %.
29. The method according to any one of statements 26 to 28, wherein the compound complexing Fe(II) is selected from the group consisting of an alkali silicate, an alkanolamine, a sugar or a sugar derivative with oxygen, nitrogen, sulphur or phosphorous anchoring donor groups, an organic acid such as ascorbic acid or tannic acid, a polyaminocarboxylate, such as EDTA, a molecule comprising a N═C—C═N moiety such as bipyridine or ferrozine, and a phosphonate.
30. The method according to any one of statements 26 to 29, wherein the compound complexing Fe(II) is Li, Na, or K silicate.
31. The method according to any one of statements 26 to 30, wherein the wet milling is performed at a pH of >7, typically >10, preferably >12.
32. The method according to any one of statements 26 to 31, wherein the alkaline conditions are induced by an alkaline solution, selected from one or more of the group consisting of hydroxides, silicates, sulphates, sulphides, sulphites, carbonates of Li- and/or Na- and/or K- and/or Ca, spent Bayer liquor, and Na-aluminate solution which is the liquid component of bauxite residue slurry.
33. The method according to any one of statements 26 to 32, wherein the alkaline conditions are provided by adding a Si-containing compound to a Li, Na, K or Ca containing solution.
34. The method according to any one of statements 26 to 33, where first an alkaline solution and then a Si-containing compound are mixed, and subsequently the Fe-comprising glass is added.
35. The method according to any one of statements 26 to 34, wherein the compound complexing Fe(II) is at a concentration of between 0.5 wt. % and 1, 5, 10, 20, or 25% of the Fe-comprising glass.
36. The method according to any one of statements 26 to 35, wherein during the milling the amount of water per ton Fe-comprising glass is between 10 and 50000 litre.
37. The method according to any one of statements 26 to 36, wherein the Fe-comprising glass is selected from the group consisting of non-ferrous metallurgical slag from Cu, Pb, Pb—Zn, Zn, Fe—Ni, Ni and P metallurgy.
38. The method according to any one of statement 26 to 37, wherein the Fe-comprising glass is selected from the group consisting of vitrified bauxite residue, vitrified ash, and slag from sinter plants or high temperature furnaces such as Basic Oxygen Furnace, Top-Blown Rotary Converter, induction furnaces, and Electric Arc Furnaces, or a microwave-assisted version of one of these.
39. The method according to any one of statements 26 to 38, wherein the particles in the Fe-comprising glass prior to the reaction have an average size of less than 1 cm or less than 5 mm.
40. The method according to any one of statements 26 to 39, which is performed at a temperature up to 350° C.
41. The method according to any one of statements 1 to 15, which is performed at a pressure of up to 90 bar.
42. The method according to any one of statements 1 to 16, which is performed at a temperature of between 4° and 260° C. and a pressure of between 1 and 40 bar.
43. The method according any one of statements 1 to 17, until a product is obtained with a specific Blaine surface of between 1000 cm²/g and 7000 cm²/g.
44. The method according any one of statements 1 to 18, which is performed until particles are obtained with an average particle size <1 mm, more particularly <100 μm.
45. The method according to any one of statements 1 to 19, which is performed in the presence of compound retarding hardening.
46. The method according to any one of statements 1 to 20, which is performed in the presence of a grinding aid.
47. The method according to any one of statements 1 to 21, followed by the step of adding one or more plasticizing agent, such as a naphthalene-based superplasticizer, a lignosulphate, a naphthalene sulphonate, a protein, a melamine-based superplasticizer, a polyamide, a polycarboxylic ether (PCE) or polacrylicether (PAE)
48. The method according to any one of statements 1 to 22, followed by a step of removing heavy metals from the solution.
49. The method according to statement 23, wherein heavy metals are absorbed on a resin.
50. The method according to statement 23, wherein heavy metals are precipitated as constituents of insoluble particles.
51. The method according to statement 23, wherein heavy metals are removed by removing the liquid phase.
52. The method according to any one of statements 1 to 27, followed by a step of separating the metallic particles from the reaction mixture.
53. The method according to any one of statements 1 to 27, followed by a step of fractionating the reacted material on particle size.
54. The method according to any one of statements 1 to 28, followed by a step of storing the milled material as a moist product.
55. The method according to statement 28, wherein said moist milled material is a slurry with a viscosity higher than 10-3 Pa·s.

### DETAILED DESCRIPTION

### Figure Legends

FIG. 1. Flexural (left) and compressive (right) strength of standard mortars prepared from dry (left bars) and wet milled (right bars) Fe-rich slag.

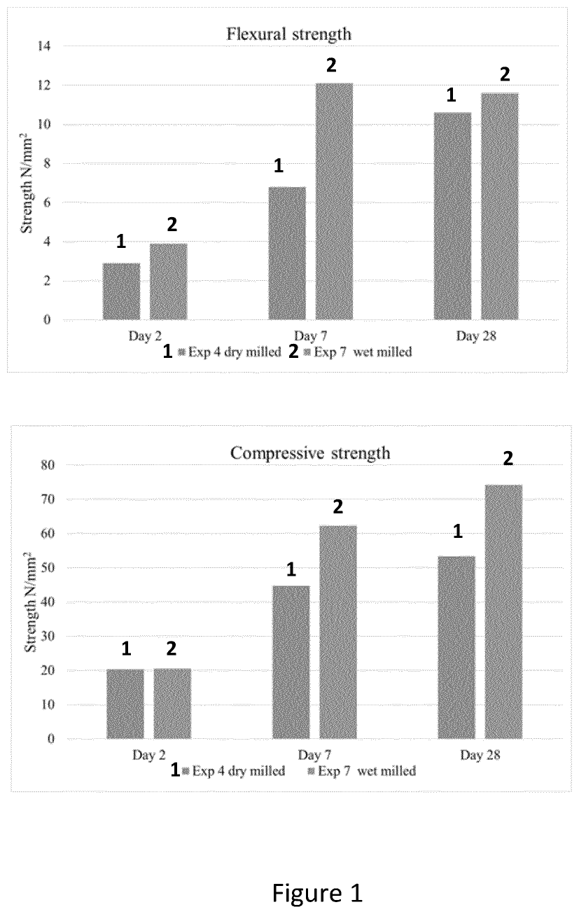

FIG. 2. Exp 1 dry milled Fe-rich glassy solid based mortar X-ray scan. The scale bar is 200 μm.

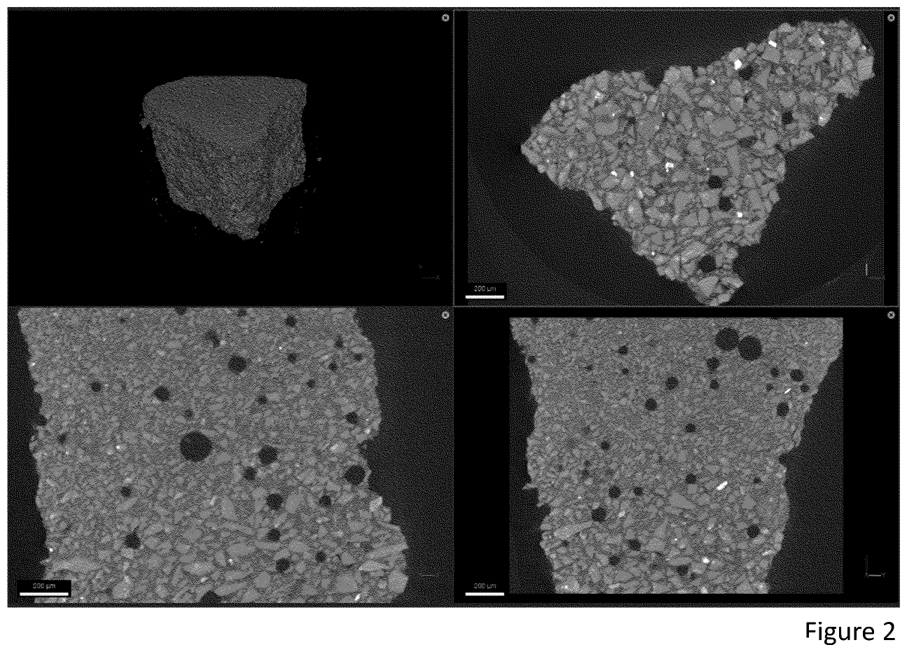

FIG. 3. Exp 3 wet (Si)-milled Fe-rich glassy solid mortars X-ray scan. The scale bar is 200 μm.

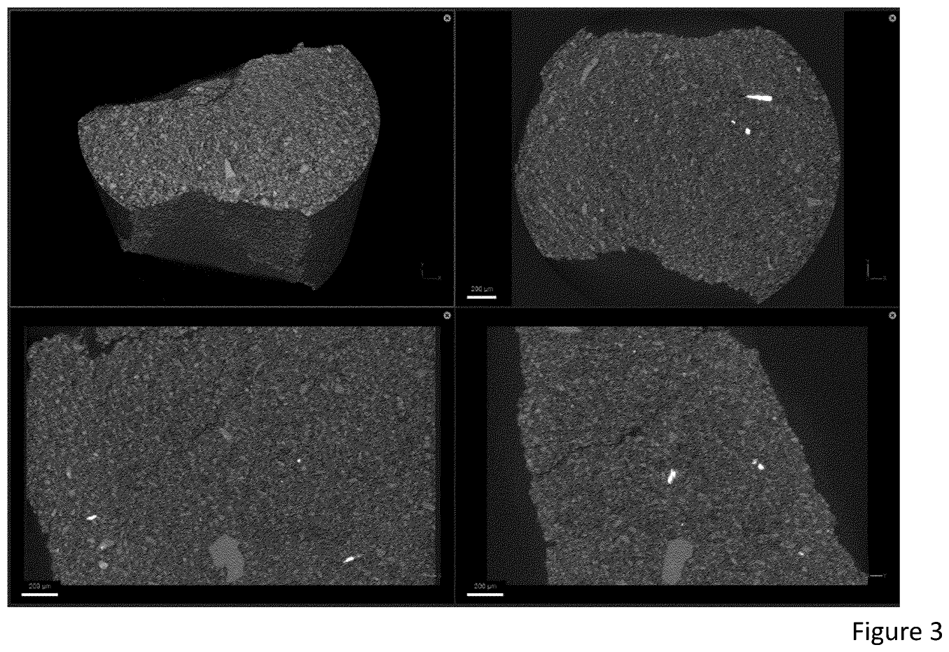

The present invention shows wet milling in the presence of agents that enhance Fe(II) complexation, both organic (e.g. [(ethylenedioxi)diethylenedinitrilo]tetra-acetic acid, EGTA) and inorganic (e.g. sodium silicate).

It was surprisingly found that grinding Fe-rich glassy solids in a solution containing both alkalis and a substantial amount (>0.1 wt. % of Fe-rich glassy solids) of Fe(II)-complexing agent (sodium silicate), leads to a glass wherein the particle size distribution of the milled product is remarkably lower compared to milling under the same conditions in air. Such a process therefore, where a Fe-rich glassy solid is milled at high pH (typically pH >10) in the presence of silicates.

Hereafter the Fe-rich glassy solid still contains the initial content of metals, and introducing Na-silicates (or K-silicates, or Li-silicates) is increasing substantially the environmental impact.

In order to reduce the environmental and economic impact, the amount of soluble silicates, as Na-silicate would be, can be zero. Instead, dry silica is introduced in a Na-containing solution and by milling and dissolution, soluble Na-silicates are created in-situ. As dry silica, one can imagine simply quartz sand. After the in-situ Na-silicate creation, the Fe-rich glassy solid is introduced in the mill. Depending on the chemistry and crystal/amorphous structure, (part of) the heavy metals are released into the slurry (example 7) and then extracted by resins, or other means. The remaining slurry is now composed of fine particles that have not yet dissolved, and a solution that contains primarily ions of Fe (as Fe²⁺ and Fe³⁺), Si, Na, Al, Ca and Mg. The ratio of Fe²⁺/Feₜₒₜ, where Feₜₒₜ=Fe⁰+Fe²⁺+Fe³⁺, is in the range of 0.05 to 1 and this guarantees the reactivity of the glue.

Embodiments of reagents and methods steps are further discussed below.

Reagents used in the methods of the invention include:

An Fe-rich glassy solid material, where the Fe content expressed as Fe₂O₃ is at least 15 wt. %, and where the Fe²⁺/Feₜₒₜ, where Feₜₒₜ=Fe⁰+Fe²⁺+Fe³⁺, is between 0.05 and 1. These can be used in a wet or dry state, wherein wet implies that there is free water. The XRD-amorphous content of this Fe-rich solid is typically >20 wt. %.

A compound or material containing Si with minimum 25 wt. % SiO₂ when expressed at oxide, equivalent to 11.7 wt. % Si, e.g. (fine) quartz.

Water-based solution of pH higher than 7, induced by oxides, hydroxides, silicates, carbonates, aluminates, aluminosulphates, sulphates, fluorides, fluorosilicates, fluoroaluminates (or aluminum hexafluorides) of an alkali metal or earth alkali-metal, or mixtures thereof.

Solid substances that release alkalis upon contact with water, such as those above or other solids which exhibit water solubility.

Complexing agents for dissolved Fe in an alkaline medium (Fe²⁺ and Fe³⁺), including salts with a functional group such as sulphonate, cyanide, phosphate, phosphonate, amine, nitrate, thiocyanide, ferrocyanide or mixtures thereof. Complexing agents also include organic acids or salts thereof such as oxalic acid, tartaric acid, tannic acid, lactic acid, citric acid, ascorbic acid, gluconic acid. Further including other molecules with ligand types selected from sugar-type ligands (e.g. glucose, fructose and others), pyridine-type ligands, ferroin-type ligands and aminopolycarboxylic-type ligands.

Fe(II) complexing compounds are known from EP4098634 and include salts having a functional group selected from sulphonate, cyanide, phosphate, phosphonate, amine, nitrate, thiocyanide, ferrocyanide, or an organic acid or salt, such as oxalic acid, tartaric acid, tannic acid, lactic acid or citric acid.

Retarders, such as EDTA or HIDP.

Grinding aids, such as:
Alcohols such as alkylene glycols with formula HO(AO)nH where A represents a C₂-C₃ alkylene and n is an integer from 1 to 5 as disclosed in U.S. Pat. No. 5,429,675,
Amines, such as alkanolamines disclosed in WO2012047450,
Organosilicones, such as those in WO2000039046A1,
Polycarboxylate ethers (PCEs),
complexing agents equally can function as be grinding aids.

Methods steps in the present invention comprise:

### Crushing

The starting material preferably has an average particle diameter less than 1 cm, ideally less than 5 mm. Particle with a diameter larger than 1 cm, can optionally be crushed by a jaw crusher, cone crusher or the like. Crushing is unlikely needed if the starting material is a water-granulated slag.

### Grinding

The grinding (also referred to as milling in the literature) is performed in a ball-mill, rod-mill, attritor mill, stirred media mill, or any other mill where there is a medium that impacts the material to be milled, and where the medium, the material to be milled, and a solution (as described above) are all present in a closed vessel. The vessel and/or the grinding media are generally made from a metallic material, e.g., steel or stainless steel, and/or from a ceramic material, e.g., YSZ. The grinding can be performed at 1 bar or higher, wherein the latter case a high-pressure vessel is used instead. In embodiments of the invention, temperatures can reach up to 350° C. and pressures can reach up to 90 bar.

### Separation

After grinding, the grinding media is separated from the slurry, and particles with certain characteristics are separated. This can be material with a certain particle size, for example coarse material that is recycled back in the process. Or material with other distinctive properties, e.g., magnetic properties.

The separation can be done within the grinding chamber, or by a stand-alone unit operation downstream in the process. Sieving, magnetic separation, sedimentation and other methods known to the people skilled in the art can be employed, e.g., centrifugal separation.

### Purification

The slurry after grinding or after separation may contain particular elements in the liquid phase that are removed for safe handling and downstream applications. This can be achieved by resins, for example resin-in-pulp or resin-in-solution, as US20110030508A1. Other processes can be used as well, including adjusting pH-Eh or adding agents for selective precipitation, as described in Yagmurlu et al. J. Sustain. Metall. 3 (2017) 90-99.

### Storage

Slurry can be stored in vessels, depending on the particularities of the mixture, for periods of more than year. Typically vessels are made from polymer-based materials.

### Liquid Glue Preparation

In the slurry additional materials can be introduced, where the milled solid fraction is >10 wt. % of the final blend,

Additional materials include:
CEMI, CEMII, CEMIII, CEMIV, CEMV, CEMVI in accordance with the EN 197
one of the eight types of portland cement according to ASTM C150: type I, type IA, type II, type IIA, type III, type IIIA, type IV, and type V
Cements, line ASTM C1157
cement clinker
CaO, Ca(OH)₂, CaCO₃,
calcium aluminate cement,
calcium sulpho aluminate cement,
calcium sulpho ferro aluminate cement, and,
a blend of a material comprising a monocalcium-, dicalcium- or tricalcium-silicate, in any one of the known polymorphs.
supplementary cementitious materials, meaning pozzolanic or (latent) hydraulic (calcium)-alumino-silicate materials such as ground granulated blast furnace slags, fly ashes, pozzolanic (natural) materials, calcined clays.
natural anhydrous, anhydrous, hemihydrate, dihydrate, ye'elimite, calcium sulpho aluminate cements, calcium sulpho ferro aluminate cements, and combinations thereof.
a Li, Na or K salt or a mixture thereof such as a silicate, aluminate, carbonate, sulphate, sulphide, nitrate, nitride or hydroxide, as solids or as a solution, or a non-pure alkali coming from side streams such as bauxite residue, cement kiln dust, aluminium anodizing sludge, and spent Bayer liquor.
a plasticizing agent such as a naphthalene-based superplasticizer, a lignosulphate, a protein, a naphthalene sulphonate-based plasticizer, a melamine-based superplasticizer, a polycarboxylic ether (PCE), polyacrylicether (PAE), a phosphonate-based superplasticizer, a polyamide (PA) polymer.

### Solid Material Preparation

The liquid glue, optionally comprising one or more of the above additional materials, further optionally comprise one or more additives.

Upon addition of one or more additives, the milled solid fraction remains >10 wt. % of the final blend.

Examples of additives are:
Aggregates of different size, chemistry, or mineralogy, both found in nature and made by humans, as specified in EN 12620 and in EN 13055
Fillers, e.g., silica fume, quartz sand or limestone, being typically fine in particle sizes, and in particular sizes where most of it (>50%) is under 63 micrometers.
Inorganic fibers such as basalt, or organic fibers such as polypropylene type fibers
Additives to induce a microstructure such as surfactants
gas-forming components such as metallic Al, or H₂O₂

### Placing or Shaping

Depending on the final use, the mixture described above as “Liquid glue preparation” or “Solid material preparation” is poured, casted or mechanically placed in a mold, as a self-levelling, vibrational or pressable mix, that can be also extruded.

### Curing

The material after placing or shaping is typically cured for up to 7 days, from −20° C. to 350° C., and from 1 bar to 90 bar. Curing continues after 7 days, but after 7 days, the quality of the materials is sufficiently high.

Intensification: operations described above can be intensified by e.g., ultrasound, microwaves, or other process intensification options.

The invention is further illustrated in the following examples.

### EXAMPLES

### Example 1: Proof-of-Concept

### Materials and Methods

The Fe-rich glassy solid in this example originated from Cu production, is therefore a slag, with the chemical composition as presented in Table 1 (XRF, S8 Tiger, Bruker) and an amorphous content of >95 wt. %. This slag was disc-milled to a size below 1 mm prior to use in the milling experiments. The silicate solution in this example (SiO₂/K₂O molar ratio of 1.7 and 65 wt. % H₂O) was produced by mixing KOH (>85% purity), pre-made silicate solution (SiO₂/K₂O weight ratio=3.36, 64.3 wt. % H₂O) and distilled H₂O.

Three milling experiments were carried out in which the slag was milled for 6 hours either in dry state, in water (in absence of soluble silicates) or in the silicate solution (Table 2). After the milling procedure, the dry and wet (water)-milled slag were subjected to thermogravimetric analysis in air (100 ml/min) between room temperature and 1000° C., with a ramp rate of 10° C./min. In addition, wet chemical analysis was conducted by dissolving 0.1 g of milled material in a mixture of 1.6 ml 40 wt. % H₂SO₄, 1.6 ml 20 wt. % HF and 0.8 ml H₂O, while covered by Ar gas. Dissolution was carried out for 2 h after which 1 g of H₃BO₃, 40 ml H₂O and 2 ml 40 wt. % H₂SO₄ was added. The Fe²⁺ content of this solution was determined by titration with a standardized 0.01N Ce(SO₄)₂ solution using a ferroin indicator.

CT-scan was done using a TESCAN UniTOM HR to see the particle size and packing in dry milled Fe-rich glassy solid, mixed with the potassium silicate solution and in the wet (Si)-milled slurry. The measurement was done using an accelerating voltage of 120 kV, a target power of 3 W and an exposure time of 545 ms. The source-to-detector distance was 300 mm, while the source-to-object distance was 5 mm. The magnification was 60× and the voxel size was 1.25 μm. The amount of projections per 360° was 2400 and 6 averages were used.

Standard mortars, according to EN 196-1, were produced using the mix-design in Table 3. The Fe-rich glassy solid was added either as dry powder (dry milled) or as a slurry together with the potassium silicate solution (wet (Si) milled). The compressive strength of these mortars was measured in accordance with EN 196-1.

TABLE 1
Chemical composition and mineralogy of the
Fe-rich glassy solid used in the examples.

| Oxide | Content (wt. %) |
|---|---|
| FeO | 41.8 |
| SiO₂ | 33.6 |
| CaO | 3.6 |
| Al₂O₃ | 10.1 |
| MgO | 1.4 |
| Na₂O + K₂O | 1 |
| Other^{a} | 8.5 |

^{a}Incl. MnO, ZnO, Cr₂O₃, P₂O₅, SO₃, CuO, TiO₂

TABLE 2
Experimental summary: milling medium,
milling media, and additives.

| Experiment No | Milling media | Additives and milling medium |
|---|---|---|
| exp 1 - dry milled | steel balls | none |
| exp 2 - wet(water) milled | steel balls | water (no soluble silicates) |
| exp 3 - wet(Si) milled | steel balls | 1.7 K₂O/SiO₂, 65 wt. % H₂O |

TABLE 3
Mix design

| | Quantity in | % of the |
|---|---|---|
| Raw Material | grams | total mix |
| Fe-rich glassy solid (milled) | 158.94 | 22.22 |
| GGBFS | 28.02 | 3.92 |
| M800 | 54.48 | 7.62 |
| Disc-milled Fe-rich glassy solid | 385.74 | 53.93 |
| Total Solids | 627.18 | 87.68 |
| K-silicate solution | 84.13 | 11.76 |

### Example 1: Inorganic Polymer

### Materials and Methods

The Fe-rich glassy material in this example originated from Cu production, with the chemical composition as presented in Table 1 (XRF, S8 Tiger, Bruker) and an amorphous content of >95 wt. %. This slag was disc-milled to a size below 1 mm prior to use in the milling experiments. Silicate solutions with SiO₂/Na₂O weight ratio of 2.5 and 70 wt. % H₂O were produced by mixing NaOH (99% purity), pre-made silicate solution (SiO₂/Na₂O weight ratio=3.36, 64.3 wt. % H₂O) and distilled H₂O. The sand used to produce mortars is CEN standard sand, as described in EN196-1.

Milling was conducted using a vertical stirred media mill with a pin-type stirrer and chrome-steel milling balls (10 mm). Disc-milled slag was milled for different times, depending on the silicate solution, using a ball-to-slag weight ratio of 4 and, in the case of wet milling, with a Na-silicate solution (liquid/slag=0.5) with SiO₂/Na₂O weight ratio of 2.5 and water content of 70 wt. %.

Mortar preparation was done using a solution-to-binder ratio of 0.5 and sand-to-binder weight ratio of 1.5. The mixing procedure was according to EN 196-1 albeit with double the amounts per mixing to have sufficient material for filling the molds (3 times 40×40×160 mm).

### Results

Table 4 shows that the energy is considerably lower for wet milling in the alkali silicate solutions compared to dry milling. Furthermore, the compressive strength is higher at all curing times when wet milling is employed as well. In fact, when the sodium silicate solution with SiO₂/Na₂O weight ratio of 2.5 is used for mixing with a dry pre-milled slag, no hardening was observed until 28 days and thus the samples could not be demoulded or tested at 2 and 7 days. However, using the wet milling procedure where the slag is milled for the same time (1 h) in the same solution (SiO₂/Na₂O=2.5, 70 wt. % H₂O), the mortars set within a day and significant strength development is observed, up to 25 MPa after 28 days.

TABLE 4
Milling energy and compressive strength after 2, 7 and 28 days
curing at 20° C. and >95% relative humidity for inorganic
polymers made using dry milled powder or using a slurry produced
through wet milling in the alkali-silicate solution. Standard
deviations of compressive strength in parentheses.

| Solution | Milling | | Milling | Curing | Compressive |
|---|---|---|---|---|---|
| SiO₂/Na₂O | time | | energy | time | strength |
| weight ratio | (h) | Wet/Dry | (kWh/t) | (days) | (MPa) |
| 2.5 | 1 | Dry | 187.5 | 2 | No setting |
| | | | | 7 | No setting |
| | | | | 28 | 5.3 (±0.2) |
| | | Wet | 155 | 2 | 15.7 (±0.1) |
| | | | | 7 | 20.4 (±0.5) |
| | | | | 28 | 25.3 (±1.2) |

### Example 2: Hybrid Binder

### Materials and Methods

The Fe-rich glassy solid in this example originated from Cu production, with the chemical composition as presented in Table 1 (XRF, S8 Tiger, Bruker) and an amorphous content of >95 wt. %. This slag was disc-milled to a size below 1 mm prior to use in the milling experiments. A silicate solution with SiO₂/Na₂O weight ratio of 1.6 and 90 wt. % H₂O was produced by mixing NaOH (99% purity), pre-made silicate solution (SiO₂/Na₂O weight ratio=3.36, 64.3 wt. % H₂O) and distilled H₂O. The sand used to produce mortars is CEN standard sand, as described in EN196-1.

Milling was conducted using a vertical stirred media mill with a pin-type stirrer and chrome-steel milling balls (10 mm). Disc-milled slag was milled for 1 hour using a ball-to-slag weight ratio of 4 and, in the case of wet milling, with a Na-silicate solution (liquid/slag=0.625 or 0.5).

Mortar preparation was done using a sand-to-binder weight ratio of 1.5. The mixing procedure was according to EN 196-1, albeit with double the amounts per mixing to have sufficient material for filling the molds (3 times 40×40×160 mm³). The dry powder (dry milling) or wet slurry (wet milling) was mixed with an additional amount of Portland cement (Holcim, CEM I 52.5N; 20 wt. % of the total solid binder (cement+slag) content), leading to a liquid/(slag+cement) content of 0.5 or 0.4, prior to the sand addition. The workability was determined according to European standard EN 1015-3.

### Results

Table 5 shows that the energy requirement of wet milling in alkali silicate solution is lower than that for dry milling. At the same time, the compressive strength at all curing times is increased considerably when a wet milled slurry rather than dry milled material mixed with alkali silicate is used for mortar production. Wet milling in alkali silicate solution does reduce the consistency of the resulting mortar, yet even for a similar workability (Wet, L/S=0.5 vs Dry, L/S=0.4), the strength is still increased at early ages (2 and 7 days).

TABLE 5
Milling energy and compressive strength after 2, 7 and 28 days
curing at 20° C. and >95% relative humidity for hybrid
binders made using dry milled powder or using a slurry produced
through wet milling in the weak alkali-silicate solution.
Standard deviations of compressive strength in parentheses.

| | | Milling | | Curing | Compressive |
|---|---|---|---|---|---|
| L/S | | energy | Consistency | time | strength |
| (mixing) | Wet/Dry | (kWh/t) | (mm) | (days) | (MPa) |
| 0.5 | Dry | 180 | >300 | 2 | 1.9 (± 0.1) |
| | | | | 7 | 3.9 (± 0.1) |
| | | | | 28 | 6.1 (± 0.3) |
| | Wet | 145 | 265 | 2 | 3.8 (±0.2) |
| | | | | 7 | 5.8 (± 0.2) |
| | | | | 28 | 8.5 (± 0.2) |
| 0.4 | Dry | 180 | 255 | 2 | 2.9 (±0.1) |
| | | | | 7 | 4.6 (± 0.1) |
| | | | | 28 | 10.4 (± 0.0) |
| | Wet | 155 | 170 | 2 | 5.2 (± 0.0) |
| | | | | 7 | 8.0 (± 0.4) |
| | | | | 28 | 12.8 (± 0.5) |

### Example 3: Impact of Slurry Shelf-Time

### Materials and Methods

The slurry was produced as defined in example 3. However, the slurry was stored in a closed bottle, to avoid water loss, for 24 h prior to mixing and casting. This mixing and casting was done using the same method as example 3 as well.

### Results

Keeping the slurry produced for the hybrid binder for an additional 24 h before use in mortar production further increase the strength gain, more so at the lower liquid/solid weight ratio, as presented in Table 6. In fact, in most cases the compressive strength is more than doubled compared to when a dry milled Fe-rich glassy solid is used. The consistency of mortars produced using wet milled slurry is reduced slightly by storing the solution for 24 h prior to use.

TABLE 6
Milling energy and compressive strength after 2, 7 and 28 days
curing at 20° C. and >95% relative humidity for hybrid
binders made using dry milled powder or using a slurry produced
through wet milling in the weak alkali-silicate solution,
including after storing the solution for 24 h prior to use.
Standard deviations of compressive strength in parentheses.

| | | Milling | | Curing | Compressive | |
|---|---|---|---|---|---|---|
| L/S | | energy | Consistency | time | strength | |
| (mixing) | Wet/Dry | (kWh/t) | (mm) | (days) | (MPa) | |
| 0.5 | Dry | 180 | >300 | 2 | 1.9 | (± 0.1) |
| | | | | 7 | 3.9 | (± 0.1) |
| | | | | 28 | 6.1 | (± 0.3) |
| | Wet | 145 | 265 | 2 | 3.8 | (±0.2) |
| | | | | 7 | 5.8 | (± 0.2) |
| | | | | 28 | 8.5 | (± 0.2) |
| | Wet | 145 | 225 | 2 | 5.1 | (± 0.1) |
| | (24 h | | | 7 | 7.6 | (± 0.5) |
| | stored) | | | 28 | 9.5 | (± 0.7) |
| 0.4 | Dry | 180 | 255 | 2 | 2.9 | (±0.1) |
| | | | | 7 | 4.6 | (± 0.1) |
| | | | | 28 | 10.4 | (± 0.0) |
| | Wet | 155 | 170 | 2 | 5.2 | (± 0.0) |
| | | | | 7 | 8.0 | (± 0.4) |
| | | | | 28 | 12.8 | (± 0.5) |
| | Wet | 155 | 160 | 2 | 7.3 | (± 0.1) |
| | (24 h | | | 7 | 13.6 | (±0.5) |
| | stored) | | | 28 | 22.1 | (±0.8) |

### Example 5: Solid Silicates

### Materials and Methods

The Fe-rich glassy solid in this example originated from Cu production, with the chemical composition as presented in Table 1 (XRF, S8 Tiger, Bruker) and an amorphous content of >95 wt. %. This slag was disc-milled to a size below 1 mm prior to use in the milling experiments. A Silicate solution with SiO₂/Na₂O weight ratio of 2.0 and 70 wt. % H₂O was produced by mixing NaOH (99% purity), pre-made silicate solution (SiO₂/Na₂O weight ratio=3.36, 64.3 wt. % H₂O) and distilled H₂O. M31 quartz sand (Sibelco, d₅₀=370 μm) was used to produce a Na-silicate solution with the same SiO₂/Na₂O weight ratio of 2.0 and 70 wt. % H₂O. The sand used to produce mortars is CEN standard sand, as described in EN196-1.

Milling was conducted using a vertical stirred media mill with a pin-type stirrer and chrome-steel milling balls (10 mm). Disc-milled slag was dry and wet milled for 50 min using a ball-to-slag weight ratio of 4. In the case of wet milling with Na-silicate solution, a liquid/slag weight ratio of 0.5 was used. In another experiment, the Na-silicate solution was produced in-situ by milling distilled H₂O, M31 quartz sand (Sibelco, d₅₀=370 μm) and NaOH together for 1 hour. The ratio's between H₂O, SiO₂ (from M31) and Na₂O (from NaOH) were the same as those present in a Na-silicate solution with SiO₂/Na₂O weight ratio of 2.0 and 70 wt. % H₂O. Subsequently, the disc-milled Fe-rich glassy solid was added ((H₂O+SiO₂+Na₂O)/(slag)=0.5) and milling continued for another 50 min.

Mortar preparation was done using a solution-to-binder ratio of 0.5 and sand-to-binder weight ratio of 1.5. The mixing procedure was according to EN 196-1 albeit with double the amounts per mixing to have sufficient material for filling the molds (3 times 40×40×160 mm³).

### Results

Table 7 shows that when relatively coarse quartz powder is used to create a silicate solution by high-intensity milling, the milling energy of milling the slag afterwards is unaffected. Furthermore, when the slurry is used afterwards a hardened product is still obtained, showing that the Fe-rich glassy solid remains reactive, although the compressive strength of the mortars is reduced compared to when a pre-made alkali silicate solution is used in the wet milling step.

TABLE 7
Milling energy and compressive strength after 2, 7 and 28 days
curing at 20° C. and >95% relative humidity for inorganic
polymers made using dry milled powder or using a slurry produced
through wet milling in either a pre-made alkali-silicate solution
or produced by milling solid silicates together with an alkali
solution for 1 h prior to slag addition. Standard deviations
of compressive strength in parentheses.

| Solution | Milling | | Milling | Curing | Compressive |
|---|---|---|---|---|---|
| SiO₂/Na₂O | time | | energy | time | strength |
| weight ratio | (h) | Wet/Dry | (kWh/t) | (days) | (MPa) |
| 2.0 | 0.83 | Wet | 130 | 2 | 13.8 (±0.8) |
| | | | | 7 | 15.5 (±1.7) |
| | | | | 28 | 20.6 (±0.6) |
| | | Wet | 130 | 2 | 2.6 (±0.2) |
| | | (solid | (290) | 7 | 7.6 (±0.0) |
| | | SiO₂) | | 28 | 6.4 (±0.1) |

1. A method for preparing an inorganic glue from an Fe-comprising material,
wherein the Fe-comprising material has an Fe content expressed as Fe₂O₃ of at least 15 wt. %,
wherein the Fe-comprising material is between 5 and 100 wt. % amorphous, and,
wherein the Fe-comprising material has an Fe²⁺/(Fe⁰+Fe²⁺+Fe³⁺) ratio of between 0.05 and 1,
the method comprising the step of milling the Fe-comprising material with a liquid, the liquid comprising a compound complexing Fe(II) under alkaline conditions,
wherein the compound complexing Fe(II) is a Li, Na or K silicate, in a concentration expressed as SiO₂, of at least 0.15 wt. % of the Fe-comprising material,
or wherein the compound complexing (FeII) comprises at least one salt having a functional group selected from sulphonate, cyanide, phosphate, phosphonate, amine, nitrate, thiocyanide, ferrocyanide, or an organic acid salt thereof, including aminopolycarboxylic acids and salts, in a concentration of between 0.001 to 5 wt. % of the Fe-comprising material.

2. The method according to claim 1, wherein the compound complexing Fe(II) is Li, Na, or K silicate.

3. The method according to claim 1 or 2, wherein the compound complexing Fe(II) is Li, Na, or K silicate, in a concentration expressed as SiO₂, of at least 1.5 wt. %, or of at least 15 wt. % of the Fe-comprising material.

4. The method according to any of claims 1 to 3, wherein the Fe-comprising material has an Fe²⁺/(Fe⁰+Fe²⁺+Fe³⁺) ratio of between 0.5 and 1.0.

5. The method according to any one of claims 1 to 4, wherein the Fe-comprising material has an Fe²⁺/(Fe⁰+Fe²⁺+Fe³⁺) ratio of between 0.75 and 1.0.

6. The method according to any one of claims 1 to 5, wherein the Fe comprising material has an Fe content expressed as Fe₂O₃ of at least 30 wt. %.

7. The method according to any one of claims 1 to 6, wherein the Fe comprising material has an Fe content expressed as Fe₂O₃ of at least 50 wt. %.

8. The method according to any one of claims 1 to 7, wherein the Fe comprising material has an Fe content expressed as Fe₂O₃ of at least 70 wt. %.

9. The method according to any one of claims 1 to 8, wherein the Fe-comprising material is more that 30% amorphous.

10. The method according to any one of claims 1 to 9, wherein the Fe-comprising glass is more that 50% amorphous.

11. The method according to any one of claims 1 to 10, wherein the wet milling is performed at a pH of >7, typically >pH 10, preferably >pH 12.

12. The method according to any one of claims 1 to 11, wherein the alkaline conditions are induced by an alkaline solution, selected from one or more of the group consisting of hydroxides, silicates, sulphates, sulphides, sulphites, carbonates of Li- and/or Na- and/or K- and/or Ca, spent Bayer liquor, and Na-aluminate solution.

13. The method according to any one of claims 1 to 11, wherein the alkaline conditions are provided by adding a Si-containing compound to a Li, Na, K or Ca containing solution.

14. The method according to any one of claims 1 to 13, where first an alkaline solution and a Si-containing compound are mixed, and subsequently the Fe-comprising material is added.

15. The method according to any one of claims 1 to 14, wherein the compound complexing Fe(II) is at a concentration of between 0.5 wt. % and 1, 5, 10, 20, 25, or 50% of the Fe-comprising material.

16. The method according to any one of claims 1 to 15, wherein the Fe-comprising material is selected from the group consisting of non-ferrous metallurgical slag from Cu, Pb, Pb—Zn, Zn, Fe—Ni, Ni and P metallurgy.

17. The method according to any one of claims 1 to 15, wherein the Fe-comprising material is selected from the group consisting of vitrified bauxite residue, vitrified ash, and slag from sinter plants or high temperature furnaces.

18. The method according to any one of claims 1 to 17, wherein the particles in the Fe-comprising material prior to the milling have an average size of less than 1 cm or less than 5 mm.

19. The method according to any one of claims 1 to 18, wherein the milling is performed at a temperature up to 350° C., for example between 225° to 245° C.

20. The method according to any one of claims 1 to 19, wherein the milling is performed at a pressure of up to 90 bar, for example between 27 to 32 bars pressure.

21. The method according any one of claims 1 to 20, wherein the milling is performed until a product is obtained with a specific Blaine surface of between 1000 cm²/g and 7000 cm²/g.

22. The method according any one of claims 1 to 20, which is performed until particles are obtained with an average particle size <1 mm, more particularly <100 μm.

23. The method according to any one of claims 1 to 22, followed by the step of adding one or more plasticizing agent, such as a naphthalene-based superplasticizer, a lignosulphate, a naphthalene sulphonate, a protein, a melamine-based superplasticizer, a polyamide, a polycarboxylic ether (PCE) or polacrylicether (PAE)

24. The method according to any one of claims 1 to 23, followed by a step of removing heavy metals from the liquid with milled Fe-comprising material.

25. The method according to any one of claims 1 to 24, followed by a step of storing the milled Fe-comprising material as a moist product.
